(19) United States
(12) Patent Application Publication
(10) Pub. No.: US 2010/0168377 A1
(43) Pub. Date: Jul. 1, 2010

(54) Catalytic conversion of amide compounds to methyl ether polymers and methyl ether ladder polymers

(75) Inventor: Melvin Keith Carter, Lincoln, CA (US)

Correspondence Address: Mk Carter, 2300 Sutter View Lane, Lincoln, CA, 95648, US

(73) Assignee: Carter Technologies, Lincoln, CA (US)

(21) Appl. No.: 12/317,796

(22) Filed: Dec. 29, 2008

(51) Int. Cl. C08G 73/00

(52) U.S. Cl. 528/368

(57) ABSTRACT

Catalytic processes have been developed for direct chemical conversion of amides to methyl ether polymers or methyl ether ladder polymers. Amides formed by reacting acetic acid with monoethanol amine (MEA) or acetic acid with butylamine were polymerized in the presence of transition metal catalysts in air to form linear polymers. Ethanol acetamide was catalytically converted to a linear polyether as characterized by FTIR spectra. The catalysts were based on molecular strings of mono-, di- or tri-valent transition metal compounds that opened the amide carbonyl double bond to produce linear polyethers. Laboratory results have demonstrated [cobalt(II)]₂, [manganese(II)]₂, cobalt(II)-manganese(II), [nickel(II)]₂ and related families of catalysts to be effective for formation of methyl ether polymers by this process.

Similar transition metal catalysts plus hydrogen peroxide facilitated reactions of the amide compounds dimethylacetamide (DMAc), DMF as well as amides formed from L-cysteine with MEA, serine with MEA, arginine with MEA and histidine with MEA to form insoluble methyl ether ladder polymers at or near ambient temperature that were quite different from the linear polyether polymers. Catalysts active for these polymerizations were based on di- or tri-valent transition metals. The polymer formed from DMAc using a Co(III) catalyst plus 20% hydrogen peroxide was a ladder polymer as characterized by FTIR spectroscopy and isolated solids were observed to be microscopic hexagonal needle shaped crystals. The catalysts were based on molecular strings of tri-valent transition metal compounds. Laboratory results have demonstrated [cobalt(III)]₂ and related families of catalysts in the presence of hydrogen peroxide to be effective for formation of methyl ether ladder polymers.

### REFERENCES CITED

U.S. Patent Documents

| Pat. No. | Issue Date | Author | Description |
|---|---|---|---|
| 5,426,242 | Jun. 20, 1995 | JR Moxey | two step process for preparing polyethers from diols, such as |
| | | | 1,6-heptanediol, and ethylene oxide in boron trifluoride |
| 5,180,856 | Jan. 19, 1993 | M Stehr and H-W Voges | polyethers from tetrahydrofuran, alkanols and glycidyl ether in |
| | | | boron trifluoride etherate |
| 5,143,998 | Sep. 1, 1992 | D Brennan, A Haag, and | prepared functionalized amide-ether polymers from diglycidyl |
| | | J White | ether of 4,4′-isopropylidene bisphenol and α,α′-bis |
| 4,978,805 | Dec. 18, 1990 | R Baur, S Birnbach, A Oftring | converted epichlorohydrin and ethylene oxide to polyethers in |
| | | and E Winkler | strong inorganic base |
| 4,946,890 | Aug. 7, 1990 | M Meador | prepared ladder polymers from 1,4,5,8-tetrahydro-1,4,5,8- |
| | | | diepoxyanthracene and a bis-diene |

### BACKGROUND

1. Field of Invention

This invention relates to a catalytic chemical process for conversion of amide type carbonyl compounds to methyl ether polymers or methyl ether ladder polymers. Amide reactants that were heated in air to just below the boiling point in the presence of a mono-, di- or tri-valent transition metal catalysts produced linear polyethers. Polymerization occurred as a result of the catalyst causing a carbonyl type double bond to open, react with a neighbor reactant and continue until a polyether had formed. Alternatively, reactions conducted using a tri-valent transition metal catalyst near ambient temperature with the addition of hydrogen peroxide formed ladder polyether compounds.

2. Description of Prior Art

A search of the prior art in categories including polyethers, polymers formed from amides and ladder polymer formation did not disclose similar catalytic chemical reaction processes. Prior art discloses U.S. Pat. No. 5,426,242 issued to J R Moxey on Jun. 20, 1995 that teaches a two step process for preparing alkyl polyethers from diols, such as 1,6-heptanediol, and ethylene oxide in the presence of potassium hydroxide or a Lewis acid such as boron trifluoride at elevated temperature. U.S. Pat. No. 5,180,856 issued to M Stehr and H-W Voges on Jan. 19, 1993 describes formation of alkyl polyethers from tetrahydrofuran, alkanols and glycidyl ether in the presence of boron trifluoride etherate at elevated temperature. R Baur, S Birnbach, A Oftring and E Winkler were issued U.S. Pat. No. 4,978,805 issued on Dec. 18, 1990 describing conversion of epichlorohydrin and ethylene oxide to alkyl polyethers in strong inorganic base. These polyether amides contain ethylene oxide and longer carbon group alkylene oxide bonding.

An article entitled, Polyaldol Condensation of Acetaldehyde by Transition Metal Alkyls, by T. Yamamoto, S. Konogaya and A. Yamamoto published in Journal of Polymer Science: Polymer Letters Volume 16, Issue 1, pages 7-12, 2003, disclosed formation of cyclic methyl ether, propyl ether compounds using anhydrous transition metal alkyls under vacuum. These compounds are unstable in an aqueous environment as taught in the present application and immediately decompose to yield no useful products.

U.S. Pat. No. 5,143,998 issued to J D Brennan, A Haag, and J White on Sep. 1, 1992 teaches preparation of functionalized amide-ether polymers from diglycidyl ether of 4,4′-isopropylidene bisphenol and α,α′-bis(4-hydroxybenzamido)-1,3-xylene. Here again these polyether amides contain ethylene oxide and longer alkylene oxide bonding functions.

The methyl ether polymers described as taught herein are quite different from those described above. These polymers are distinguished from repeating ethyl ether, propyl ether and other alkyl or aryl ether polymeric compounds disclosed previously as they comprise repeating [—C(R)(NR′R″)—O—]ₓ units. They are formed by catalytic action where a carbonyl type double bond is opened to form methyl polyethers. Said polyethers possess chemical bonding different from the ethyl, propyl and longer polyethers described above as exhibited by characteristic FTIR intense absorption bands in the 1180 to 1080 cm⁻¹ and 790 to 680 cm⁻¹ regions.

A review of prior art for formation of ladder polymers discloses U.S. Pat. No. 4,946,890 issued to M Meador on Aug. 7, 1990 that teaches a process for preparation of ladder polymers from 1,4,5,8-tetrahydro-1,4,5,8-diepoxyanthracene and a bis-diene.

Methyl ether ladder polymers as taught herein are quite different again from polyethers described in previous patent literature in that they are formed from a single amide compound and comprise a pair of parallel repeating (—C—O—)ₓ molecular units separated by cross links comprising —CH═CH— or —CR═CR—. They are formed by catalytic action on an amide type carbonyl double bond that is opened to form methyl polyethers. Said polyethers possess chemical bonding quite different from the polyethers described in prior patent literature as exhibited by characteristic intense FTIR absorption bands in the 1465 to 1395 cm⁻¹ region plus two of the following three absorptions bands dependant on chemical bonding, in the 880 to 870 cm⁻¹, 750 to 705 cm⁻¹ and 490 to 475 cm⁻¹ regions.

### SUMMARY OF THE INVENTION

This invention describes a catalytic chemical process for conversion of amide type carbonyl compounds to methyl ether polymers or methyl ether ladder polymers. A broad range of strings of mono-, di- and tri-valent transition metal catalysts with inorganic sulfate, phosphate or borate co-catalysts facilitate conversion to methyl polyethers. These are different from ethylene glycol and other alkenol polyethers as the physical properties of the polymers disclosed herein are dry and tough compared to polyethylene glycol polymers that exhibit wax-like properties.

It is an object of this invention, therefore, to provide a mono-metal or string transition metal catalytic process facilitating conversion of amide type carbonyl compounds to methyl ether polymers or methyl ether ladder polymers. Other objects of this invention will be apparent from the detailed description thereof that follows, and from the claims.

### DETAILED DESCRIPTION OF THE INVENTION

A process is taught for catalytic chemical conversion of amide type carbonyl compounds to methyl ether polymers or methyl ether ladder polymers. These polymers are distinguished from repeating ethyl ether, propyl ether and other alkyl ether polymeric compounds disclosed previously as they comprise repeating [—C(R)(NR′R″)—O—]ₓ units. Repeating ethyl ether linkages, such as polyethylene glycols found in the prior art, are characterized by weak to moderately strong infrared spectral absorption in the 1150 to 1060 cm⁻¹ range (L. J. Bellamy, “The Infrared Spectra of Complex Molecules”, volume I, chapter 7, page 131, 3^{rd} edition, Chapman and Hall, published 1986) where as repeating methyl ether polymers disclosed in this application are characterized by intense infrared spectral absorption in the 1200 to 1100 cm⁻¹, 800 to 670 cm⁻¹ and 624 to 594 cm⁻¹ regions. A broad range of individual as well as strings of mono-, di- or tri-valent metal catalysts based on mono-metal and other transition metal compounds, such as [vanadium(II)]₂, [chromium(II)]₂, [manganese(II)]₂, cobalt(II)-manganese(II), [cobalt(II)]₂, [cobalt(III)]₂, [nickel(II)]₂ and similar transition metal compounds, for which the transition metals and directly attached atoms possess C₄ᵥ, D₄ₕ or D_{2d} point group symmetry. These catalysts have been designed based on a formal theory of catalysis, Concepts of Catalysis, and the catalysts have been produced, and tested to prove their activity. The theory of catalysis rests upon a requirement that a catalyst possess a single metal atom or a molecular string of transition metal atoms of the required symmetry such that electronic transitions from one molecular electronic configuration to another be barrier free so reactants may proceed freely to products as driven by thermodynamic considerations. Catalysts effective for chemical conversion of amides to products comprise mono-metal, di-metal, tri-metal and/or poly-metal backbone or molecular string type compounds of the transition metals comprising titanium, vanadium, chromium, manganese, iron, cobalt, nickel, copper, zirconium, niobium, molybdenum, ruthenium, rhodium, palladium, silver, hafnium, tantalum, tungsten, rhenium, technetium, osmium, iridium, platinum, gold or combinations thereof in addition to co-catalysts. Co-catalysts comprise Li₂SO₄, Na₂SO₄, K₂SO₄, CaSO₄, BaSO₄, other sulfates, phosphates, nitrates and borates.

Methyl ether ladder polymers as taught herein are distinctly different from polyethers described in previous patent literature in that they comprise a pair of parallel repeating (—C—O—)ₓ molecular units separated by cross links comprising —CH═CH— or —CR═CR—. They are formed by catalytic action using transition metal pairs comprising a type of [cobalt(III)-cobalt(III)] or [manganese(III)-manganese(III)] transition metal complex of the required symmetry with hydrogen peroxide where an amide type carbonyl double bond is opened to form methyl polyethers. Said polyethers possess chemical bonding quite different from the polyethers described in prior patent literature as exhibited by characteristic intense FTIR absorption bands in the 1465 to 1395 cm⁻¹ region plus two of the following three absorptions dependant on chemical bonding, 880 to 870 cm⁻¹, 750 to 705 cm⁻¹ and 490 to 475 cm⁻¹ regions.

Amide type carbonyl compounds comprising DMF, DMAc, NMBAc, MEHx, amides prepared from solutions of organic acids comprising serine, arginine or histidine, reacted with amines comprising monoethanolamine, butylamines, methylpropylamines are polymerized by divalent and trivalent transition metal compounds. Said amides and related carbonyl type compounds are polymerized to ladder polymers near ambient temperature or to linear polymers by heating below their boiling temperatures in the presence of a catalyst.

### Linear Polymers

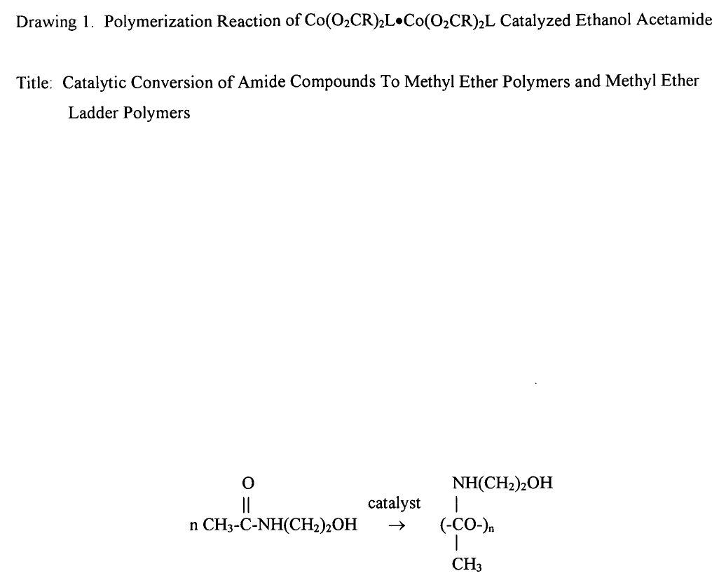

First row transition metal catalysts like V(O₂CR)₂L.V(O₂CR)₂L, for O₂CR comprising stearic acid or tetrachlorocatechol, L comprising sulfates or phosphates and transition metals comprising V(II), Cr(II), Mn(II), Co(II) or Ni(II), all divalent transition metals. A cobalt catalyst acted on ethanol acetamide made from a 1:1 mixture of acetic acid+MEA in air in the presence of a co-catalyst of support material (L) comprising CaSO₄, K₂SO₄, related sulfates phosphates or borates to form linear polymers. Reactions were conducted in glass vials open to the air in one to four hours at 150° C. to 200° C. An FTIR spectrum of the polymeric products exhibited absorption bands at 3433, 2958, 2919, 2850, 1632, 1202, 1153, 1114, 686, 612 and 594 cm⁻¹. Absorption at 1202 cm⁻¹ and 1153 cm⁻¹ that correlated with —C—O— motion indicating a linear ether group had formed. Each repeating unit was indicated to be chemically bound to the next in the chain by means of a —C—O— link. This indicated that the divalent transition metal catalysts had opened carbonyl type double bonds to form linear polymeric chains as shown in FIG. 1.

### [Insert Drawing 1 Here]

### Ladder Polymers

Chemical reactions were conducted at 25° C. to 45° C. in 25 mL glass vials without stirring using a few milligrams of a transition metal catalyst, a few drops of 20% hydrogen peroxide, 6 grams of a carbonyl type compound comprising N,N-dimethylacetamide (DMAc), N,N-dimethylformamide (DMF) or an amide formed from L-cysteine with MEA, serine with MEA, arginine with MEA or histidine with MEA plus sufficient pure water to dissolve or disperse the amide. Reaction times ranged from a few hours to several weeks with regular addition of 1 to 2 drops of hydrogen peroxide for insoluble colorless micro-crystalline products to form, although typical reaction times were two days to two weeks. Reactions were terminated by decanting the liquid portion leaving some solid residue in the vials. These residues were rinsed repeatedly with a minimum volume of pure water, rinsed three times with a minimum volume of ethanol and air dried at 45° C.

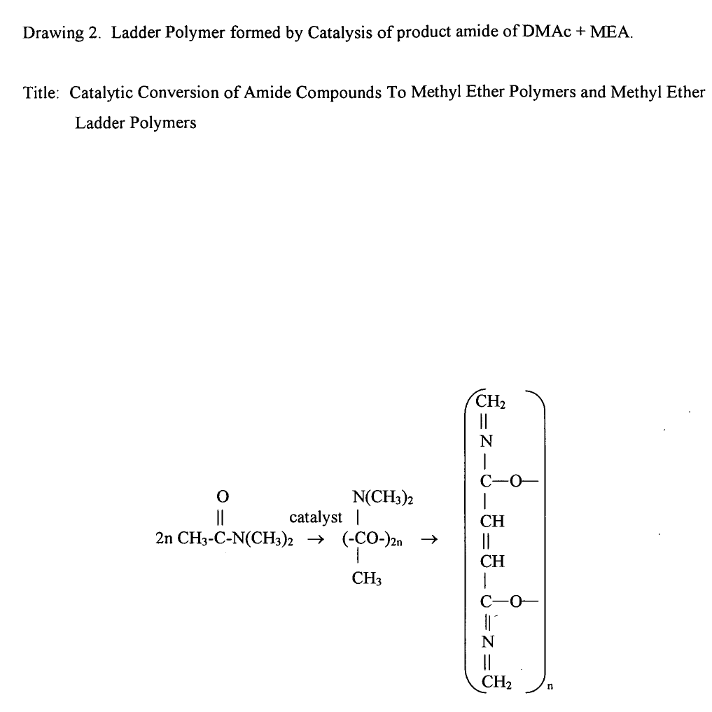

Polymers of DMAc formed using the CO₂(C₆Cl₄O₂)₂[C₆Cl₄(OH)₂]₂ catalyst, cobalt being tri-valent, were different from those identified as linear polymers. An FTIR spectrum recorded for a KBr pellet of the water insoluble micro-crystalline polyether products exhibited one moderate band located at 3333 cm⁻¹, three intense absorption bands located at 1426, 732, 481 cm⁻¹ and weak bands at 3140, 3039, 2809, 1831, 1618, 1404, 1185 to 1203 and 960 cm⁻¹. The three intense bands located at 1426, 732 and 481 cm⁻¹ correlated with —C—O— motion of the ladder polymer. Here the 1426 cm⁻¹ band for the ladder polyether did lie at a substantially higher wave number value than the equivalent band located at 1202 cm⁻¹ to 1153 cm⁻¹ for the linear polymer indicating the —C—O— bond of the ladder polyether to be strained as indicated in FIG. 2.

### [Insert Drawing 2 Here]

Product crystals of DMAc and DMF were insoluble in common solvents including fluorinated solvents at room temperature but were soluble in molten 1,8-dihydroxy anthraquinone (DHAQ) at 200° C. Formation of a substituted methyl ether ladder polymer molecule from two DMAc molecules resulted in formation of a relatively rigid symmetric ribbon molecule allowing for the possibility of regular crystal formation. Separate needle crystals observed under a microscope were straight with flat sides and a hexagonal cross section.

### Catalyst Selection Considerations

The Concepts of Catalysis effort forms a basis for selecting molecular catalysts for specified chemical reactions through computational methods by means of the following six process steps. An acceptable polymerization mechanism, involving a pair of metal atoms, was established for carbonyl compounds (step 1). A specific transition metal, such as cobalt, was selected as a possible catalytic site as found in an M-M or Co—Co string (step 2), for one metal atom bonded with two to four reactant carbonyl type molecules in a C₄ᵥ, D₄ₕ or D_{2d} point group symmetry configuration, and having a computed bonding energy to the associated reactants of less than −60 kcal/mol (step 3). The first valence state for which the energy values were two-fold degenerate was +2 (step 4), although triplet type compounds may be employed with valence of +3. Sulfate, phosphate or other anions can be chosen provided they are chemically compatible with the metal, M or Co, in formation of the catalyst (step 5). A test should also be conducted to establish compliance with the rule of 18 (or 32) to stabilize the catalyst so compatible ligands can be added to complete the coordination shell (step 6). This same process can be applied for selection of a catalyst using any of the first, second or third row transition metals, however, only those with acceptable negative bonding energies can produce effective catalysts. The approximate relative bonding energy values were computed using a semi-empirical algorithm. This computational method indicated that any of the first row transition metal complexes could produce usable catalysts once the outer coordination shell had been completed with ligands, even though the elements V, Cr, Mn, Fe, Co and Cu indicated acceptable bonding energies using the simplified molecular model. Second row and third row transition metal complexes were also indicated to produce active polymerization catalysts. In general, preliminary energy values computed for transition metal complexes were indicated to produce useable catalysts once bonding ligands had been added.

### DESCRIPTION OF CATALYST PREPARATION

Preparation of the CO₂(C₆Cl₄O₂)₂[C₆Cl₄(OH)₂]₂ catalyst was conducted as described. To 0.0267 gram (0.1 mmol) of Co(NH₃)₆Cl₃ dissolved in 2 mL of pure water was added 0.0496 gram (0.2 mmol) of tetrachlorocatechol dissolved in 2 to 4 grams of a heated ethanol acetone mixture. The combined mixture was heated to approximately 100° C. for two to four minutes to form the dark brown catalyst complex. A polymerization reaction was initiated at ambient temperature by placing approximately 0.05 grams of catalyst, 2 grams of pure water, 2 grams of DMAc and a few drops of 20 percent hydrogen peroxide in a 25 mL glass vial for several days where small needle shaped crystals formed. An FTIR spectrum recorded for a KBr pellet of the water insoluble reaction products exhibited one moderate absorption band located at 3333 cm⁻¹, three intense absorption bands located at 1426, 732, 481 cm⁻¹ with weak bands at 3140, 3039, 2809, 1831, 1618, 1404, 1185 to 1203 and 960 cm⁻¹.

### EXAMPLE 1

Preparation of the Co(O₂CR)₂L.Co(O₂CR)₂L catalyst, for L being CaSO₄, was conducted using the above process. To 0.0249 gram (0.1 mmol) of cobalt (II) acetate tetrahydrate was added 0.0569 gram (0.2 mmol) of stearic acid, 1.0 gram of calcium sulfate and 0.4 gram of pure water. The mixture was heated to approximately 100° C. for two minutes to form the catalyst.

### EXAMPLE 2

Preparation of the Cr(O₂CR)₂L.Cr(O₂CR)₂L catalyst, for L being Li₂SO₄, was conducted in a similar fashion. To 0.0158 gram (0.1 mmol) of chromium (III) chloride was added 0.0569 gram (0.2 mmol) of stearic acid, 1.0 gram of lithium sulfate, 0.065 gram of zinc dust [to reduce Cr(III) to Cr(II)] in the absence of air and 0.4 gram of pure water. The mixture was heated to approximately 100° C. for two minutes to form the catalyst.

### EXAMPLE 3

Preparation of the V(O₂CR)₂L.V(O₂CR)₂L catalyst, for L being K₂SO₄, was conducted by a process similar to that described above. To 0.0182 gram (0.1 mmol) of vanadium pentoxide was added 0.0569 gram (0.2 mmol) of stearic acid, 1.0 gram of potassium sulfate and 0.4 gram of pure water. The mixture was heated to approximately 100° C. for two minutes to form the catalyst. The mixture turned colorless as the reduced valance vanadium formed at the beginning of the reaction.

### EXAMPLE 4

Preparation of the CO₂(C₆Cl₄O₂)₂[C₆Cl₄(OH)₂]₂ catalyst was conducted as follows. To 0.0267 gram (0.1 mmol) of Co(NH₃)₆Cl₃ dissolved in 2 mL of pure water was added 0.0496 gram (0.2 mmol) of tetrachlorocatechol dissolved in 2 to 4 grams of a heated ethanol acetone mixture. The mixture was heated for two to four minutes to form a dark brown catalyst complex.

### Description of Catalytic Polymerization Reactions

### Preparation 1

To the catalyst solution in example 1, contained in a 25 mL glass vial, was added 1.00 gram of glacial acetic acid and 1.01 gram of ethanolamine to form an amide when heated. A screw cap vial was closed and then opened slightly to allow water vapor to vent and air to enter. The vial was rapidly heated to 200° C. and heating continued in the 190° C. to 200° C. range for four hours. The liquid became solid after approximately one half hour as the product formed. After four hours the vial was cooled and opened to remove the solid liner polyether polymer.

### Preparation 2

To the catalyst solution in example 2, contained in a 25 mL glass vial, was added 1.00 gram of glacial acetic acid and 1.22 gram of n-butylamine to form an amide when heated. A screw cap was closed and then opened slightly to allow water vapor to vent and air to enter. The vial was rapidly heated to 200° C. and heating continued in the 190° C. to 200° C. range for four hours. The liquid became solid after four hours, the vial was cooled and opened to remove the solid liner polyether polymer formed.

### Preparation 3

To the catalyst solution in example 3, contained in a 25 mL glass vial, was added 1.00 gram of glacial acetic acid and 1.01 gram of ethanolamine to form an amide when heated. A screw cap vial was closed and then opened slightly to allow water vapor to vent and air to enter. The vial was rapidly heated to 200° C. and heating continued in the 190° C. to 200° C. range for four hours. The liquid became solid after approximately one half hour as the product formed. After four hours the vial was cooled and opened to remove the solid liner polyether polymer.

### Preparation 4

To the aqueous catalyst solution in example 4, contained in a 25 mL glass vial, was added 4.00 grams of DMAc plus a few drops of 20 percent hydrogen peroxide. The vial was maintained at 20° C. to 45° C. un-capped in this temperature range. After several days a crystalline needle ladder polymer was isolated.

Drawings Follow as Drawing 1 and Drawing 2

What is claimed:

1. A process for conversion of amide compounds to polymers comprising methyl ether polymers or methyl ether ladder polymers using a transition metal catalyst and a co-catalyst.

2. A process for conversion of amide compounds to polymers comprising methyl ether polymers or methyl ether ladder polymers using a mono-, di- or tri-valent transition metal catalyst and a sulfate, phosphate, nitrate or borate co-catalyst.

3. A process for conversion of amides to polymers comprising methyl ether polymers or methyl ether ladder polymers using transition metal catalysts comprising individual or strings of mono-, di- or tri-valent metal compounds of titanium, vanadium, chromium, manganese, iron, cobalt, nickel, copper, zirconium, hafnium, niobium, tantalum, molybdenum, tungsten, rhenium, technetium, platinum, palladium, ruthenium, rhodium, osmium, iridium, silver or gold, combinations of transition metals comprising manganese-cobalt, iron-cobalt, vanadium-chromium, nickel-copper with co-catalysts comprising Li₂SO₄, Na₂SO₄, K₂SO₄, CaSO₄, BaSO₄ or related sulfates, phosphates, nitrates, borates.

4. A catalytic process for conversion of amide compounds comprising DMF, DMAc, MBAc, MEHx or amides prepared from organic acids comprising acetic acid, serine, arginine, histidine or related amino acids, reacted with amines comprising monoethanolamine, butylamines, methylpropylamines to polymers comprising methyl ether polymers or methyl ether ladder polymers.

5. A process for conversion of amide compounds comprising DMF, DMAc, MBAc, MEHx or amides prepared from organic acids comprising acetic acid, serine, arginine, histidine or related amino acids, reacted with amines comprising monoethanolamine, butylamines, methylpropylamines to polymers comprising methyl ether polymers or methyl ether ladder polymers using transition metal catalysts comprising individual as well as strings of mono-, di- or tri-valent metal catalyst compounds of titanium, vanadium, chromium, manganese, iron, cobalt, nickel, copper, zirconium, hafnium, niobium, tantalum, molybdenum, tungsten, rhenium, technetium, platinum, palladium, ruthenium, rhodium, osmium, iridium, silver or gold, combinations of transition metals comprising manganese-cobalt, iron-cobalt, vanadium-chromium, nickel-copper with co-catalysts comprising Li₂SO₄, Na₂SO₄, K₂SO₄, CaSO₄, BaSO₄ or related sulfates, phosphates, nitrates, borates.
